(19) United States
(12) Patent Application Publication
(10) Pub. No.: US 2021/0241190 A1
(43) Pub. Date: Aug. 5, 2021

(54) System and Method for Tracking, Recording and Monitoring Flow of Work Processes of Manufacturing, Assembly and Fabrication

(71) Applicant: John Bradford Janik, houston, TX (US)

(72) Inventor: John Bradford Janik, houston, TX (US)

(21) Appl. No.: 17/143,867

(22) Filed: Jan. 7, 2021

Related U.S. Application Data
(60) Provisional application No. 62/963,899, filed on Jan. 21, 2020.

(51) Int. Cl. G06Q 10/06; G06N 20/00

(52) U.S. Cl. CPC G06Q 10/0633; G06N 20/00

(57) ABSTRACT

A system and method for augmenting and automating an ERP (enterprise resource planning) system with artificial intelligence to monitor the progress with a non-intrusive technique in human assembly.

### CROSS REFERENCE TO RELATED APPLICATIONS

This patent application takes priority from U.S. Provisional patent application Ser. No. 62/963,899 filed on Jan. 21, 2020 by John Janik and entitled a System and Method for Enterprise Resource Planning which is hereby incorporated by reference in its entirety.

### BACKGROUND OF THE INVENTION

Enterprise Resource Planning and manufacturing simulation tracking software is in use worldwide.

### FIELD OF THE INVENTION

The present invention is in the field of Enterprise Resource Planning software.

### BRIEF DESCRIPTION OF THE DRAWINGS

FIG. 1 is a schematic depiction of an illustrative embodiment of the invention;

FIG. 2 is a schematic depiction of an illustrative embodiment of the invention;

FIG. 3 is a schematic depiction of an illustrative embodiment of the invention; and

FIG. 4 is a schematic depiction of an illustrative embodiment of the invention.

### SUMMARY OF THE INVENTION

A system and method for augmenting and automating an ERP (enterprise resource planning), simulation and tracking system with artificial intelligence using equipment and personnel signature to monitor the progress with a non-intrusive technique in monitoring processes in manufacturing and assembly.

### DETAILED DESCRIPTION OF AN ILLUSTRATIVE EMBODIMENT OF THE INVENTION

In a particular illustrative embodiment of the present invention, an improved Enterprise Resource Planning (ERP) and augmented manufacturing execution system (AMES) system and method are disclosed. The AMES tracks a manufacturing process made up of a series of manufacturing steps at workstations, using equipment signatures to determine which step of a manufacturing process is in progress in a manufacturing plant having at a workstation for manufacturing. In a particular illustrative embodiment of the invention a system and method are disclosed for as an AMES for augmenting and automating an ERP (enterprise resource planning) system with artificial intelligence in a processor to monitor the progress with a non-intrusive technique in human aided manufacturing, assembly and fabrication. In a particular illustrative embodiment of the invention, the system and method are used to track the flow of manufactured product subassemblies and assemblies using pattern recognition of certain power consumption patterns such as the energy profile data signature.

In a particular illustrative embodiment of the invention, the system and method are also used to track weight of the subassemblies and assemblies as they pass from workstation to workstation to determining when a process step is ready to proceed and when process step is complete. Verification of weights from a bill of materials indicates when a process is ready to proceed and when the process is complete. In a particular illustrative embodiment of the invention, the automatic pattern recognition using artificial intelligence recognizes the known patterns of energy data power profiles and energy signatures. In a particular illustrative embodiment of the invention, the system and method automatically monitor, track and record the known patterns and signatures in the power consumption of individual work processes at workstations. In a particular illustrative embodiment of the invention, the system and method automatically know when material arrives by weighing component parts of the and is processed with the input of energy with a particular energy signature. In a particular illustrative embodiment of the invention, the energy profile signature for an assembly process workstation can is monitored with electrical metering devices which determine when the energy is applied and when the energy is stopped. In a particular illustrative embodiment of the invention, the system and method, using the monitored energy profile signatures, in turn sends signals to the ERP system and the processor in the AMES that the workstation has started and stopped working on the assembly and subassembly of the manufactures part with known start and stop time stamps. This information is then be used as inputs to track and validate simulations of the assembly and subassembly product flow automatically. Time signatures are gathered for all signatures and used by the AMES to determine when a process step is started, complete and at what point within a process step is currently being processed.

In a particular illustrative embodiment of the invention, a bill of materials (BOM) is used at each workstation to provide known the weights of materials from a database of materials which is be queried as materials and component parts of the bill of materials are accumulated at the workstation for the assembly of subcomponents and subassemblies. These known weights are weight signatures for an assembly and/or subassembly. The combined weight of the assembled materials for an assembly is matched with the combined known materials weights for the assembly and subassembly that are indicated to the AMES and ERP system of the assembly, when the subassembly and/or assembly is completed. The subassembly's monitored weight at its workstation matches the predetermined weight and workstation based on the bill of material and records a zero tare on the scale. The system and method determine when the subassembly has been removed based on the weight, energy profile, acoustic signature and thermal signature and determines when that the part or subassembly has been completed as a step in the process. This subassembly completion is time stamped and recorded to indicate the flow of production of the subassembly and assembly. The data can is then compared to the simulated results for further feedback, tuning and optimization of the processes, and used as inputs to track and validate simulations of the assembly and subassembly product flow automatically.

In a particular illustrative embodiment of the invention, an acoustic signature of known sounds for a given process step are monitored and utilized for feedback and confirmation of performance of process steps based on the acoustic signature. The acoustic signature is stored in the database and forms a known acoustic signature that evolves over time as the artificial intelligence learns the acoustic signatures and time stamps for the process step. In a particular illustrative embodiment of the invention, thermal signatures from infrared cameras are used to monitor process steps and also indicate if a human is present at the workstation. The noticeable and recognizable signatures of power consumption patterns and weights are separately or used together effectively in the manufacturing and production of standardized products to track, record and monitor the flow of the work processes of standardized component manufacturing, assembly and fabrication.

In a particular illustrative embodiment of the invention, commercially available EPICOR and global shop ERP Systems are used. In a particular illustrative embodiment of the invention, commercially available SimCad Pro simulates material handling and production flow to develop, simulate, control and automate flow. The system and method update the EPICOR and global shop ERP Systems and SimCad Pro to correct and improve the performance of EPICOR and global shop ERP Systems and SimCad Pro.

In a particular illustrative embodiment of the invention, the system and method use artificial intelligence machine learning to monitor all of the signatures disclose herein to simplify and automate decision-making for assembly process control and tracking. The system and method learn when a shortage of raw material of production capacity should trigger an alert to and a cancellation of a customer order. The system and method learn when a shortage personnel of production capacity should trigger a cancellation of a customer order. The system and method improve such decision-making over time using signature monitoring and artificial intelligence to reduce costs, increase manufacturing efficiency, and improve productivity and customer service through the on-time delivery of products made up of assemblies and subassemblies.

In a particular illustrative embodiment of the invention, the system and method track and archives energy consumption as energy profiles by energy consuming equipment or groups of equipment at a workstation(s) in the database. The actual energy consumption data may include only one electrical meter reading or one gas meter reading (or both) for each category/subcategory of equipment involved in a process step. Each piece of energy consuming equipment is monitored individually by a smart dedicated electric or gas consumption sensor. Any sensor or meter can used to monitor energy consumption and add to the energy profile signature.

In another particular illustrative embodiment of the invention a system and method are disclosed as an integrated enterprise resource planning and an augmented manufacturing execution system (AMES) which includes a middleware component and a signature monitoring facility coupled to the middle ware component, the signature monitoring facility includes an augmented manufacturing execution system and a real time dispatch system. The augmented manufacturing execution system tracks overall processing of the manufacture of assemblies and subassemblies. The integrated enterprise resource planning and augmented manufacturing execution system progress the product record which includes a product identifier, a facility identifier and an enterprise resource planning material identifier. These facilities are initialized to include an ERP material create function, a product validation function, a product mapping function and a shipping facility function. The progress of manufacturing an assembly and subassembly information record includes a subassembly name, a manufacturing process flow description and a bill of materials level for the manufacturing process flow. The manufacturing process flow includes but is not limited to a description of steps that are executed during manufacture of the assembly and subassembly.

In another particular illustrative embodiment of the invention, the system and method use a bill of material is associated with an enterprise resource planning system. Product serial numbers refer to a unique number given to each component of an assembly and subassembly manufacture for a given product. This number is used to identify and track the manufacturing process of all manufactures for the assemblies and subassemblies for a given product.

In another particular illustrative embodiment of the invention, the system and method provide an enterprise resource planning (ERP) system and AMES to track the flow of materials throughout their system. The system and method o fully track the provenance of materials or components used in a product subassembly. An AMES system and method for tracking supply and production and records keep track of the weight of an assembly and subassembly that is produced and shipped to a client. The AMES system and method validates the request for correctness and completeness of request parameters and then ensure that there is sufficient material (quantity, volume, weight) available to fulfill the manufacture of assemblies and sub assemblies. The bill of materials describes items and materials used in a production of an assembly and sub assembly.

In another particular illustrative embodiment of the invention, the system and method are provided where sustainability factors such as energy signatures are monitored throughout a plant or process and associated with a model such as a bill of material in order to increase plant efficiencies. The AMES system and method enables extracting energy signatures or other consumption data from the plant floor workstations or other sources of sustainability factor data and correlating it to production output. Energy monitoring profiles on the production floor are tied to an energy profile tracking software package and correlate production output to the energy signature over time of power consumed. Energy is metered and the empirical results are added to the production Bill of Material (BOM). The additional metering provides enough granularity for the user to measure the energy used by various elements within the process or manufacturing system under a variety of operating conditions.

Manufacturing execution systems (MES) are computerized systems used in manufacturing to track and document the transformation of raw materials to finished goods. MES provides information that helps manufacturing decision makers understand how current conditions on the plant floor can be optimized to improve production output. MES works in real time to enable the control of multiple elements of the production process (e.g. inputs, personnel, machines and support services). In a particular illustrative embodiment of the invention, an augmented manufacturing execution system (AMES) and are disclosed.

In a particular illustrative embodiment of the invention, a system and method provide an AMES that operates across multiple function areas, for example: management of product definitions across the product life-cycle, resource scheduling, order execution and dispatch, production analysis and downtime management for overall equipment effectiveness (OEE), product quality, or materials track and trace. AMES creates the “as-built” record, capturing the data, processes and outcomes of the manufacturing process. This can be especially important in regulated industries, such as food and beverage or pharmaceutical, where documentation and proof of processes, events and actions may be required.

The idea of AMES is an intermediate step between, on the one hand, an enterprise resource planning (ERP) system, and a supervisory control and data acquisition (SCADA) or process control system on the other; although historically, exact boundaries have fluctuated. Industry groups such as MESA International—Manufacturing Enterprise Solutions Association were created in the early 1990s in order to address the complexity, and advise on execution, of MES Systems.

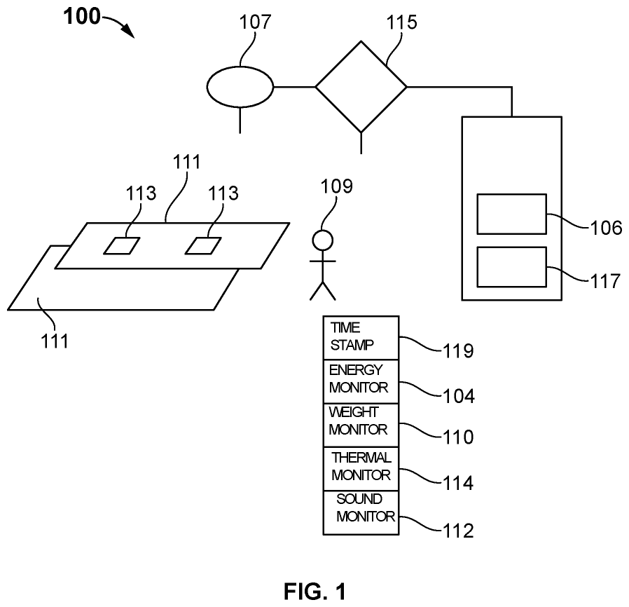

Turning now to FIG. 1, in a particular illustrative embodiment of the invention, as shown in FIG. 1, a schematic representation 100 of an AMES in a manufacturing environment such as a manufacturing facility plant is disclosed. As shown in FIG. 1, a processor 105 connects with a computer readable medium containing a computer program for tracking the process, a database 117 and artificial intelligence software 106 in a machine learning environment. The processor collects time stamps 119, energy profiles from energy monitor 104, weights from weight monitor 110, thermal signatures from thermal monitor 114 and acoustic signatures from sound monitor 112 and an acoustic sensor such as a microphone 107. A workstation(s) 111 in a manufacturing plant is associated with a particular assembly manufacture. Materials 113 which are components of a sub assembly are tracked and weighed on the workstation as they arrive at a workstation. A human worker 109 is detected by a video/infrared cameral 115. If a human work is needed and is not present for a particular manufacturing step in the process, an alert is sent by the processor to have an human report to the workstation to help perform the process step. If a human work is not needed and is present for a particular manufacturing step in the process, an alert is sent by the processor to have the human report to a different workstation where a human is needed to help perform a different process step.

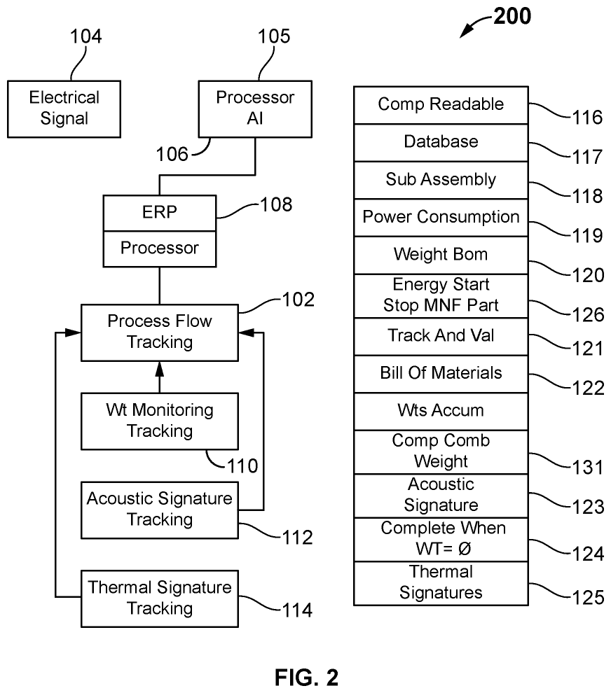

Turning now to FIG. 2, in a particular illustrative embodiment of the invention system and method, an architectural system block diagram 200 of the AMES is depicted. The blocks each include a processor or are connected to a processor with a computer readable medium. As shown in FIG. 2, a processor flow tracking function 102 monitors and records weights of components of an assembly or a subassembly that is used by the process to determine when all components of an assembly of are present at a particular workstation. A power signature from an electrical signature meter 104 is time stamped and used by the process flow tracking function to determine when a process step in an assembly and subassembly manufacturing process is started and completed and at what point within a process step the subassembly process is at currently. An acoustic signature 112 from a sound monitor device such as a microphone (not shown) is time stamped is used by the process flow tracking function to determine when a process step in an assembly and subassembly manufacturing process is started and completed. A thermal acoustic signature 114 from a thermal monitor device such as a thermometer and infrared camera is time stamped and used by the process flow tracking function in the processor to determine when a human being worker is present during a process step in an assembly and subassembly manufacturing process is started and completed. A weight monitor 110 such as a scale at a workstation is time stamped is used by the system and method process flow tracking function to determine when components for process step in an assembly and subassembly manufacturing process are ready to be started and completed.

The processor is in data communication, that is sending and receiving data between the processor and a computer readable medium containing a data base 117, wherein data base is stored in the computer readable medium 116. The data base includes a data structure that includes but not limited to data fields containing data that are accessed by the processor to read and write data in the data structure fields. The data structure may include but is not limited to a sub assembly field 118, power consumption patterns 119 such as energy profiles and energy signatures and time stamps for assembly process steps, a bill of materials component weights for an assembly 120, energy profiles and signatures and time stamps for an assembly process step 126, process tracking and product flow simulation values 121 for input and correction to a product manufacture simulation, a bill of materials (BOM) 122 for an assembly, an accumulation of weights 131 for components of the BOM that make up an assembly wherein the accumulated weights are compared with the combined weight of BOM to determine when all materials have arrived at a work station and weight when an assembly is completed 131, an acoustic signature field 123 for storing data indicative of an acoustic signature and time stamps for an assembly process step wherein the acoustic signature tracks and records acoustic signatures at workstation.

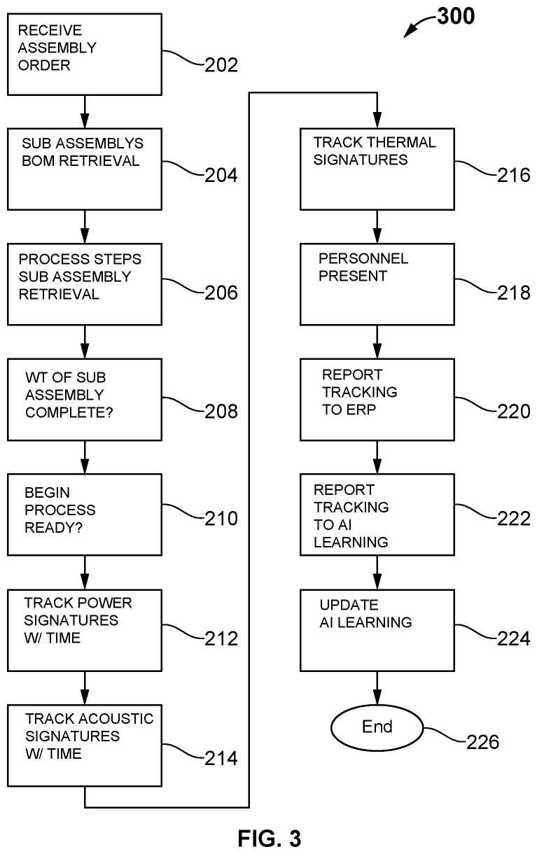

Turning now to FIG. 3, a flow chart of functions performed in a particular illustrative embodiment of the system and method of the invention is depicted. As show in FIG. 3, the AMES receives an assembly order at 202. The sub assemblies and BOM are retrieved from the data base at 204. At 206 process steps for the sub assembly are retrieved from the data base. At 208 the weight for the sub assembly are retrieved from the data base and weight monitor to determine when the components for a sub assembly are available at a workstation. At 210 the AMES when the BOM materials and human workers necessary to perform manufacture of an assembly are present at a workstation and the process step is ready to begin. At 212 the power profiles and power signatures and time stamps of functions of steps performed during an assembly at a workstation are monitored. At 214, acoustic signatures and time stamps for an assembly process step are monitored and recorded, including but not limited to manual human worker steps and machinery steps in the process. At 216 thermal signatures are monitored and recorded with time stamps to determine the presence and absence of a human worker 218 at a workstation. At 220 the AMES reports all monitoring and tracking of the manufacturing assembly steps shown in FIG. 3 to the ERP and to the artificial intelligence (AI) software at 222. The AI software 224 monitors the tracked manufacturing steps to learn the and improve the process and the simulation of the process. The end of the functions flow chart is at 226.

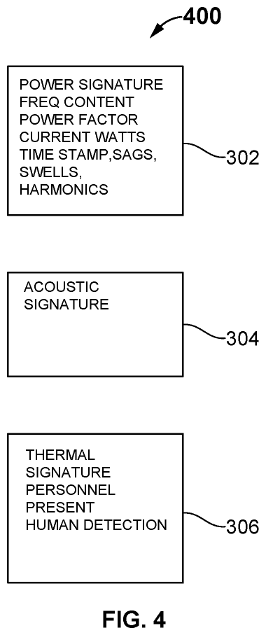

Turning now to FIG. 4, signature data structures 400 are depicted as stored in the computer readable medium. As shown in FIG. 4, a power signature field 302 has a frequency content filed, power field, current field, wattage field, power factor field and time of occurrence for power signature characteristics. An acoustic signature data structure 304 is provided to store data for acoustic signatures associated with machine noise and human initiated noise for assembly process steps. At 306 a thermal signature data structure is provided for determining when a human worker is present at a workstation for an assembly process step. All signature fields are augmented with additional data fields in the data structure whenever an additional element of a signature is monitored. For example, a power factor will be added to a power signature if not already present in the energy signature data structure.

Power Signatures

Power signatures are disclosed in United States Patent Application 20200310507 Kind Code A1 HANES; David H. issued Oct. 1, 2020 and entitled GENERATING POWER SIGNATURES FOR ELECTRONIC DEVICES, which is incorporated by reference herein in its entirety.

Power signature monitoring extracts useful information about any system that uses electromechanical devices. It has a low installation cost and high reliability because it uses a bare minimum of sensors. It is possible to use modem state and parameter estimation algorithms to verify remotely the “health” of electromechanical loads by using Power signature monitoring to analyze measured waveforms associated with the operation of individual loads. Power signature monitoring can also monitor the operation of the electrical distribution system itself, identifying situations where two or more otherwise healthy loads interfere with each other's operation through voltage waveform distortion or power quality problems.

Another component of a power signature is a sag. A sag is a reduction of AC voltage for a duration of 0.5 cycles to 1 minute of time. Sags are usually the result of heavy load startups. Typical causes of sags include starting up of large equipment such as large motors or HVAC units that might be connected to the same internal power distribution line in the facility. For example, a motor can draw up to six times normal running current during startup. This type of sudden load will typically impact the rest of the circuit that the large equipment resides on, just as at home you will notice an impact on your lights when something with a high draw is plugged in. A sag and an associated time stamp are used by the processor to determine a point within a process step that is being executed and when it is being executed. An power signature expert system within the artificial intelligence identifies these sags or under voltages so you can understand what's happening with your electrical system with specific times and outputs.

Another component of the power signature is a swell. Sags, Swells or over-voltages are the reverse of a sag and has increased AC voltage for a duration of 0.5 cycles to 1 minute in time. Much like sags, the condition is hard to detect without effective instrumentation, so the problem is typically ignored or not diagnosed. Typically this is caused by sudden large load reductions. Often the results of swell show up as data errors, flickering lights, electrical contact degradation, semiconductor damage and insulation damage all of which can cause catastrophic results in the facility.

Another component of a power signature is harmonics. In some manufacturing process steps, harmonic distortions are self-induced because of increased usage of variable frequency drives, computer AC/DC power converters, new LED lighting and other components that may cause solid-state switching. The system and method of the present invention record these harmonic values over a prolonged period.

Another component of a power signature is power factor. Power factor is the ratio of working power to apparent power. A power factor in a power signature is monitored and used by the processor to determine at what point a step in a process is in at each time on an associated time stamp.

Human Detection

Detection of humans using infrared cameras is disclosed in U.S. Pat. No. 9,811,065 Chen, et al. issued on Nov. 7, 2017, and entitled Human detection system and human detection method, which is hereby incorporated by reference herein in its entirety. See also, U.S. Pat. No. 9,349,042 by Takenaka, et al. issued on May 24, 2016 which is hereby incorporated by reference herein in its entirety. A human detection and tracking apparatus, human detection and tracking method, and human detection and tracking program is disclosed. In another particular illustrative embodiment of the invention, a passive infrared sensor is used to detect the presence of humans. Human detection using sensors preserves the privacy. The Passive Infrared (PIR) sensor is used to detect the presence of human. But this detects the human only if they are in motion. Grid-EYE sensor overcomes the limitation of PIR sensor by detecting the human at stationary position. The Grid-EYE sensor detects the human using the infrared radiation radiated by the human body. Every human radiates the infrared energy of specific wavelength range. The absorbed incident radiation changes the temperature of a material. In this paper detection of a human using Grid-EYE sensor is proposed. The Grid-EYE sensor is a thermal infrared detector consisting of 64 thermopile elements arranged in a specific grid format. The Grid-EYE sensor is able to detect moving object, motionless object and also the direction of movements. The Grid-EYE sensor provides the temperature data of a human present at stationary as well as moving position. Using these temperature data as an input detection of a human at stationary and tracking of a human at moving position using Kalman filter is presented in this paper.

Acoustic Signatures

Acoustic Signatures are disclosed in United States Patent Application 20190237094 Kind Code A1 KAKADIARIS; loannis; et al. issued on Aug. 1, 2019 and entitled, SYSTEMS FOR AND METHODS OF INTELLIGENT ACOUSTIC MONITORING, which is incorporated herein by reference in its entirety. A system for intelligent acoustic monitoring. The system includes a microphone to capture environmental acoustic data and a processor coupled to the microphone. The processor is configured to receive and perform acoustic analysis on the captured acoustic data to generate an acoustic signature, based on a result of the acoustic analysis, identify an event indicated by the acoustic signature, and perform a remedial action based on the identified event. See also, United States Patent Application 20180203925, Kind Code A1 Aran; Nir Jul. 19, 2018, entitled SIGNATURE-BASED ACOUSTIC CLASSIFICATION, which is hereby incorporated by reference in its entirety. A method for acoustic classification is disclosed which may include generating, based at least on one or more user inputs, a first association between an acoustic signature and a classification. The generation of the first association may include storing, at a database, the first association between the acoustic signature and the classification. A second association between the classification and an action may be generated including by storing, at the database, the second association between the classification and the action. An association between a sound and the classification can be determined based on the sound matching the acoustic signature. In response to the sound being associated with the classification, the action associated with the classification can be performed. Related systems and articles of manufacture, including computer program products, are also provided.

Include text from claims, etc.

1. A system for monitoring a work process for an assembly, the system comprising:
a processor in data communication with a computer readable medium, wherein the computer readable medium contains a computer program stored thereon;
a workstation monitored by the processor;
a plurality of sensors at the workstation for monitoring signatures of a process flow of an assembly, wherein the computer program determines a progress of the process workflow for the from the plurality of signatures.

2. The system of claim 1, the system further comprising:
an energy monitoring device for determining an energy profile data signature for an equipment indicating the progress of the workflow at the workstation, wherein the energy monitoring device is a power meter for determining a power signature.

3. The system of claim 1, the system further comprising:
an acoustic monitoring device for determining an acoustic profile data signature indicating the progress of the workflow at the workstation, wherein the acoustic monitoring device is a microphone.

4. The system of claim 1, the system further comprising:
a monitoring device for determining when a human worker is present at the workstation, wherein the thermal monitoring device is an infrared camera.

5. The system of claim 1, the system further comprising:
a weight monitoring device for determining a weight of assembly components accumulated at the workstation, wherein the weight monitoring device is a scale.

6. The system of claim 1, wherein the computer program further comprises an artificial intelligent program that learns the progress of the workflow from the signatures.

7. The system of claim, wherein the computer program reports the progress of the workflow to an enterprise resource planning system.

8. The system of claim 1, wherein the processor reads the energy profile data signature, the acoustic profile data signature, the human work present to determine the progress of the process workflow.

9. The system of claim 8, wherein artificial intelligence in the process learns process steps from the energy profile data signature, the acoustic profile data signature, the human work present.

10. The system of claim 8, wherein time signatures are gathered for all signatures and used by the processor to determine when a process step is started, when a process step is completed and what point within a process step is currently being processed.

11. A method for monitoring a work process for an assembly, the method comprising:
reading on a processor, a plurality of sensors at workstation for monitoring signatures of a process flow of an assembly; and
determining a progress of the process workflow for the from the plurality of signatures.

12. The method of claim 11, the method further comprising:
determining an energy profile data signature for an equipment indicating the progress of the workflow at the workstation, wherein the energy monitoring device is a power meter for determining a power signature.

13. The method of claim 11, the method further comprising:
determining an acoustic profile data signature indicating the progress of the workflow at the workstation, wherein the acoustic monitoring device is a microphone.

14. The method of claim 11, the method further comprising:
determining when a human worker is present at the workstation, wherein the thermal monitoring device is an infrared camera.

15. The method of claim 11, the method further comprising:
monitoring device for determining a weight of assembly components accumulated at the workstation, wherein the weight monitoring device is a scale.

16. The method of claim 11, further comprising:
learning the progress of the workflow from the signatures using an artificial intelligent program.

17. The method of claim, further comprising:
reporting the progress of the workflow to an enterprise resource planning system.

18. The method of claim 11, further comprising:
reading the energy profile data signature, the acoustic profile data signature, the human work present to determine the progress of the process workflow.

19. The method of claim 18, further comprising:
learning process steps from the energy profile data signature, the acoustic profile data signature, the human work present using the artificial intelligence.

20. The method of claim 18, further comprising:
gathering all signatures to determine when a process step is started, when a process step is completed and at what point within a process step is currently being processed.
